(19) United States
(12) Patent Application Publication
(10) Pub. No.: US 2025/0304181 A1
(43) Pub. Date: Oct. 2, 2025

(54) STRUCTURE FOR IMPROVING COWL TOP WATER MANAGEMENT

(71) Applicant: Honda Motor Co., Ltd., Tokyo (JP)

(72) Inventor: TIMOTHY J. RUPP, DUBLIN, OH (US)

(21) Appl. No.: 18/619,738

(22) Filed: Mar. 28, 2024

(51) Int. Cl. B62D 25/08

(52) U.S. Cl. CPC B62D 25/081

(57) ABSTRACT

A cowl structure for a vehicle is provided. The cowl structure includes a cowl part having an end portion that is rotatably coupled at a pivot point of a wiper assembly of the vehicle. The cowl structure further includes a slider having a first end segment and a second end segment. The first end segment is disposed on an underside of the cowl part and the second end segment meets up with a wiper cover disposed on the wiper assembly such that a pocket is formed around the pivot point of the wiper assembly of the vehicle.

### BACKGROUND

A cowl top water management system of a vehicle is a distinctive automotive design feature used in various vehicles over the years. Nowadays, the cowl top water management system includes an underbody structure. Such an underbody structure located under front wipers (which direct water into an engine room area) is being removed from many structural layouts present at a base of a front facing windshield. In some cases, the vehicle uses wiper covers and numerous other components to collect and control water that enters through the cowl top. In such cases, a lot of foam is required between a wiper pivot cover and the cowl top, making the cowl top water management system expensive. Furthermore, there may be many variations in how such foam is assembled, which could result in the foam not functioning properly. Overall, this type of arrangement requires a large number of components to work together and can fail, resulting in water intrusion. This necessitates the development of a cowl structure capable of improving water management from the cowl top without the use of foam, as well as improving assembly quality. The cowl structure must be cost-effective and seal a wiper assembly and its associated components to reduce the possibility of water intrusion.

Limitations and disadvantages of conventional and traditional approaches will become apparent to one of skill in the art, through comparison of described systems with few aspects of the present disclosure, as set forth in the remainder of the present application and with reference to the drawings.

### SUMMARY

According to an embodiment of the disclosure, a cowl structure for a vehicle is provided. The cowl structure may include a cowl part having an end portion that may be rotatably coupled at a pivot point of a wiper assembly of the vehicle. The cowl structure may further include a slider having a first end segment and a second end segment. The first end segment may be disposed on an underside of the cowl part and the second end segment may meet up with a wiper cover. The wiper cover may be disposed on the wiper assembly such that a pocket is formed around the pivot point of the wiper assembly of the vehicle.

According to another embodiment of the disclosure, a vehicle body structure having a cowl structure is provided. The cowl structure may include a cowl part having an end portion that may be rotatably coupled at a pivot point of a wiper assembly of a vehicle. The cowl structure may further include a slider having a first end segment and a second end segment. The first end segment may be disposed on an underside of the cowl part and the second end segment may meet up with a wiper cover. The wiper cover may be disposed on the wiper assembly such that a pocket is formed around the pivot point of the wiper assembly of the vehicle.

According to another embodiment of the disclosure, a method of adding a slider to a cowl part of a vehicle is provided. The method may include rotatably coupling an end portion of the cowl part at a pivot point of a wiper assembly of the vehicle. The method may further include disposing a first end segment of the slider on an underside of the cowl part. Further, a second end segment may be allowed to meet up with a wiper cover. The wiper cover may be disposed on the wiper assembly such that a pocket is formed around the pivot point of the wiper assembly of the vehicle.

### BRIEF DESCRIPTION OF THE DRAWINGS

FIG. 1 is a diagram that illustrates an exemplary vehicle body structure for a vehicle, in accordance with an embodiment of the disclosure.

FIG. 2 is a diagram that illustrates an exemplary diagram of a cowl structure about a cross section B-B, in accordance with an embodiment of the disclosure.

FIG. 3 is a diagram that illustrates a side cross sectional view of a cowl structure for a vehicle, in accordance with an embodiment of the disclosure.

FIG. 4 is a diagram that illustrates a formation of a cowl structure for a vehicle, in accordance with an embodiment of the disclosure.

FIG. 5 is a flowchart that illustrates an exemplary method of adding a slider to a cowl part of a vehicle, in accordance with an embodiment of the disclosure.

The foregoing summary, as well as the following detailed description of the present disclosure, is better understood when read in conjunction with the appended drawings. To illustrate the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Various embodiments of the present disclosure may be found in a cowl structure for a vehicle. The disclosed cowl structure may include a cowl part having an end portion that may be rotatably coupled at a pivot point of a wiper assembly of the vehicle. The disclosed cowl structure may further include a slider having a first end segment and a second end segment. The first end segment may be disposed on an underside of the cowl part and the second end segment may meet up with a wiper cover. The wiper cover may be disposed on the wiper assembly such that a pocket is formed around the pivot point of the wiper assembly of the vehicle.

Traditionally, installing a cowl top water management system between a front hood and a front-facing windshield has caused a number of issues. For example, if a cowl top water management system with an underbody structure is installed between the hood and the front-facing windshield, many structural layouts must be removed in order to direct water into an engine room area via the cowl top. Furthermore, removing the underbody structure from the structural layout reduces assembly quality. However, installing wiper covers and other components for the cowl top water management system requires a large amount of foam, making the cowl top water management system expensive.

To overcome some of the abovementioned issues, the cowl structure may include the slider that may be disposed on the cowl part of the vehicle to seal space around the pivot point of the wiper assembly without requiring foam, which reduces the cost of installation of the proposed cowl structure. The cowl structure may further form the pocket around the pivot point of the wiper assembly to seal the wiper cover around the pivot point of the wiper assembly to prevent water intrusion.

Reference will now be made in detail to specific aspects or features, examples of which are illustrated in the accompanying drawings. Wherever possible, corresponding, or similar reference numbers will be used throughout the drawings to refer to the same or corresponding parts.

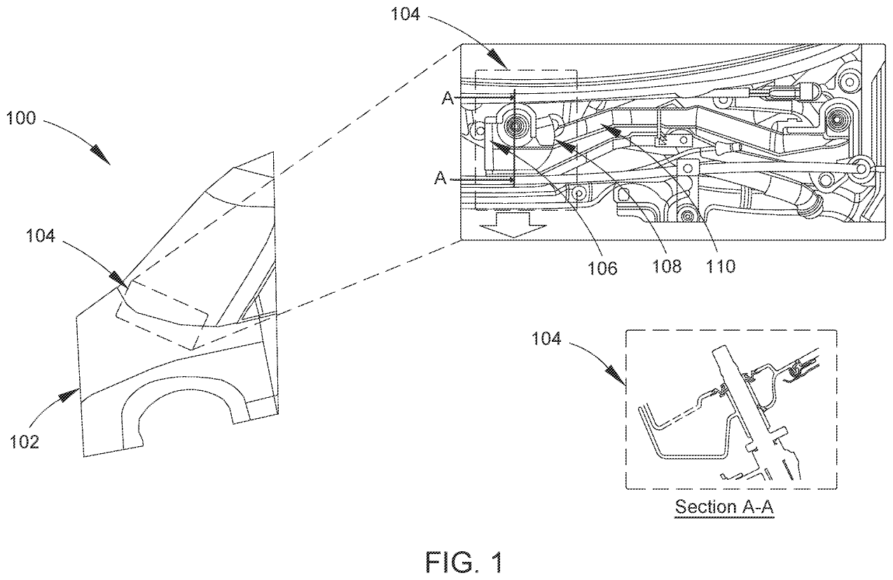

FIG. 1 is a diagram that illustrates an exemplary vehicle body structure for a vehicle, in accordance with an embodiment of the disclosure. With reference to the FIG. 1, there is shown a diagram that illustrates a vehicle body structure 100 for a vehicle 102. The vehicle body structure 100 may include a cowl structure 104 about a cross-section A-A (as shown). The vehicle body structure 100 may further include a cowl part 106, a wiper assembly 108, and a wiper cover 110.

The vehicle 102 may be a means of transport with a water management system, which may be provided in an upper area and closer to engine and passenger compartment. Such a water management system of the vehicle 102 may be an important aspect of the vehicle's design. The water management system of the vehicle 102 may include management concerning soiling, splashing, or wading, which may affect the aerodynamics of the vehicle 102. For some instances, the water management system of the vehicle 102 may include a water pump that may be configured to circulate coolant (for example, water or lubricant) around an engine compartment to regulate engine's temperature. Additionally, the water management system of the vehicle 102 may further include collection of water from windshield of the vehicle 102. The vehicle 102 may include the cowl structure 104 that may include the water management system. Examples of the vehicle 102 may include, but are not limited to, a four-wheeled vehicle, such as an electric car, an internal combustion engine (ICE)-based car, a fuel-cell based car, a solar powered-car, or a hybrid car.

The cowl structure 104 may be a support structure located at an upper area closer to an engine compartment at border between the engine compartment and the passenger compartment in a front vehicle body for the vehicle 102. The cowl structure 104 may be provided at a lower end of a front facing windshield of the vehicle 102. The cowl structure 104 may be attached at border between the engine compartment and the passenger compartment using at least one of a seal, glue, or hinge. Further, the cowl structure 104 may be configured to mount the cowl part 106.

The cowl part 106 may be a two layered structure disposed between a rear portion of a front hood and a bottom portion of the rear facing windshield of the vehicle 102. The cowl part 106 may be disposed between a rear end of a front hood and a bottom portion of a front wind shield of the vehicle 102. The cowl part 106 may be configured to hold wipers associated with the front facing windshield of the vehicle 102. In some embodiments, the cowl part 106 may be configured to collect water from the front facing windshield of the vehicle 102. By way of example, and not limitation, the cowl part 106 may collect surrounding elements (for example, leaves, debris, or twigs) and may prevent such elements from entering into the engine compartment of the vehicle 102. The cowl part 106 may be configured to mount the wiper assembly 108 of the vehicle 102.

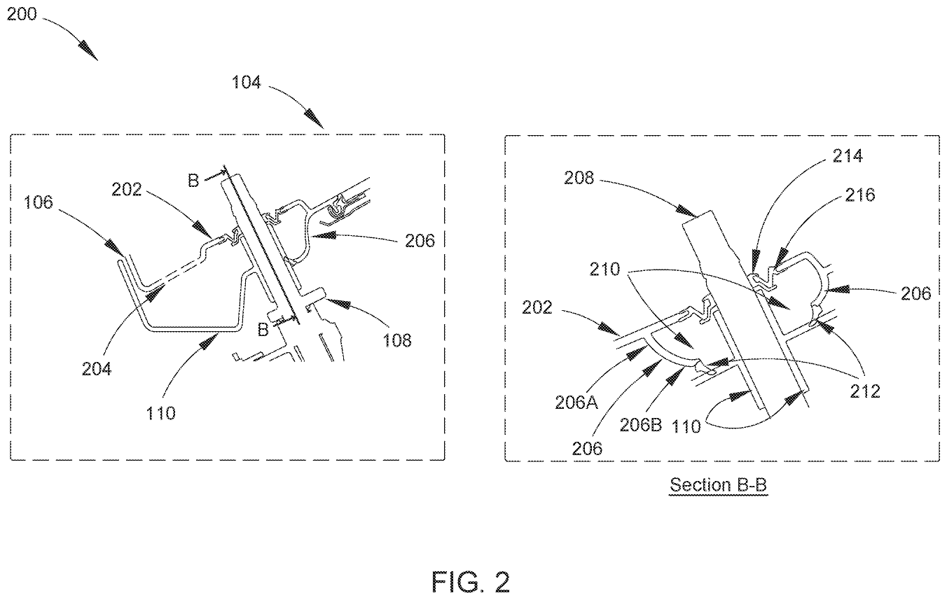

The wiper assembly 108 may include two wiper arms and a wiper drive. The wiper drive may be configured to clear water (and/or debris) from the front windshield of the vehicle 102. By clearing the water from the front windshield, the passenger may get a clear view from the front facing windshield of the vehicle 102 by moving the two wiper arms across it at a specific angle. In some instances, the wiper assembly 108 may include a rubber wiping lip which may include a unique shape that may be configured to clear water (and/or debris) from the front windshield in a more effective manner. The wiper assembly 108 may be powered using a small electric motor that may be mounted on a firewall or under the cowl part 106 of the vehicle 102. Additionally, the wiper assembly 108 may include a control system that may be configured to activate a linkage mechanism to move wiper arms back and forth. The wiper assembly 108 may include suitable mechanical or pneumatic control mechanisms that may control a movement of the wiper arms about a pivot point (for example, a pivot point 208 as shown in FIG. 2). In certain cases, the wiper assembly 108 may be manually controlled by a user. By way of example, and not limitation, the movement of the wiper arms of the wiper assembly 108 may be automatically controlled, via an electronic control unit (ECU) associated with the vehicle 102 in an autonomous mode. The wiper assembly 108 may further include the wiper cover 110.

The wiper cover 110 may be an assortment of thin or hollow material installed around the wiper assembly 108 to provide a critical support to the wiper cover 110 of the vehicle 102. The wiper cover 110 may be disposed along lateral sides of the wiper assembly 108 of the vehicle 102. The lateral sides of the wiper assembly 108 may be at least a left side or a right side of the wiper assembly 108, along a length of the wiper assembly 108. The wiper cover 110 may provide a solid covering for the wiper assembly 108 to protect the wiper assembly from surrounding elements. Additionally, the wiper cover 110 may enhance the strength of the wiper assembly 108 by providing additional structural support to the wiper assembly 108. Additionally, the wiper cover 110 may alleviate any concerns about physical damage occurring to the wiper assembly 108.

FIG. 2 is a diagram that illustrates an exemplary diagram of a cowl structure about a cross-section B-B, in accordance with an embodiment of the disclosure. FIG. 2 is explained in conjunction with elements from FIG. 1. With reference to the FIG. 2, there is shown an exemplary diagram 200 that illustrates the cowl structure 104 about the cross-section B-B. The cowl structure 104 may include the cowl part 106 having an end portion 202 and an underside 204, a slider 206 having a first end segment 206A and a second end segment 206B, a pivot point 208 of the wiper assembly 108, the wiper cover 110, a pocket 210, a gasket 212, a pivot cap 214, and a grommet 216.

The cowl part 106 may include the end portion 202 that may be rotatably coupled at the pivot point 208 of the wiper assembly 108 of the vehicle 102. The end portion 202 of the cowl part 106 may be an extension that may extend towards the pivot point 208. Further, the end portion 202 of the cowl part 106 may extend along a length of the cowl part 106. The underside 204 of the cowl part 106 may substantially face towards the wiper cover 110. Further, the underside 204 of the cowl part 106 may be a bottom side of the cowl part 106 with respect to a field of view from a top portion of the cowl part 106. In certain embodiments, the underside 204 of the cowl part 106 may be associated with either a left side or a right side of the cowl part 106 along a length of the cowl part 106.

The pivot point 208 of the wiper assembly 108 of the vehicle 102 may be located on at least a driver side portion or a middle portion of the front wind shield of the vehicle 102. The pivot point 208 of the wiper assembly 108 may be configured to allow the wiper arms of the wiper assembly 108 to rotate about an axis, which may be parallel to a lateral axis of the wiper assembly 108. The wiper arms may rotate about a single pivot point and may, therefore, have one degree of freedom. The rotational movement about the pivot point 208 may be controlled in a manual mode or a semi-autonomous mode. By way of example, and not limitation, the movement of the wiper arms of the wiper assembly 108 about the pivot point 208 may be automatically controlled, via an electronic control unit (ECU) associated with the vehicle 102. By way of another example, and not limitation, the movement of the wiper arms of the wiper assembly 108 about the pivot point 208 may be manually controlled by the user by application of resistive force to provide the required rotational movement to the wiper arms of the wiper assembly 108 about the pivot point 208 to place the wiper arms of the wiper assembly 108 in a plurality of configurations.

The slider 206 may be a knob or a level that may extend from the underside 204 of the cowl part 106. For example, the slider 206 may be substantially perpendicular to the underside 204 of the cowl part 106. In FIG. 1B, the slider 206 is shown to have a substantially non-linear shape, which is merely an example that should not be construed as limiting the disclosure. The slider 206 may be configured to seal space around the pivot point 208 of the wiper assembly 108. For example, the slider 206 may be configured to seal space around the pivot point 208 to prevent water leaking into the engine compartment.

In certain embodiments, the slider 206 may include linkages that may be attached to the underside 204 of the cowl part 106. Also, the slider 206 may have the first end segment 206A and the second end segment 206B. The first end segment 206A of the slider 206 may substantially face towards the underside 204 of the cowl part 106. The second end segment 206B of the slider 206 may be an extension that may extend towards the wiper cover 110. The second end segment 206B may meet up with the wiper cover 110 (which may be disposed on the wiper assembly 108) such that the pocket 210 is formed around the pivot point 208 of the wiper assembly 108 of the vehicle 102.

The pocket 210 may be a vacant space formed between the cowl part 106, the slider 206, and the wiper cover 110. The pocket 210 may seal the wiper cover 110 around the pivot point 208 of the wiper assembly 108 to provide an additional structure that may be configured to prevent water intrusion. For example, the pocket 210 may prevent water intrusion into the engine compartment or other components of the vehicle 102. Additionally, the pocket 210 may mitigate any chance of the slider 206 or the gasket 212 colliding with the wiper cover 110. The pocket 210 is further illustrated as an example in FIG. 2.

The gasket 212 may be an elastomeric material to establish and hold a static seal between two intersecting surface under diverse operating circumstances. The gasket 212 may be disposed between the second end segment 206B of the slider 206 and the wiper cover 110. The gasket 212 may be a two-layer structure having an inner layer with a strong sealant properties and workability, and a rubber surface layer with design on it. In FIG. 2, the gasket 212 is shown to have a substantially non-linear shape, which is merely an example that should not be construed as limiting the disclosure. The gasket 212 may be a dual injected mechanical seal that may be configured to secure the second end segment 206B of the slider 206 to the wiper cover 110. Additionally, the gasket 212, when compressed, may fill the gap between two or more mating surfaces to stop leaks into or out of the joined objects. For example, the gasket 212 may be configured to stop water leaking into the engine compartment.

The pivot cap 214 may be a cover that encloses the end portion 202 of the cowl part 106. The pivot cap 214 may be disposed between the end portion 202 of the cowl part 106 and the pivot point 208 of the wiper assembly 108 of the vehicle 102. The pivot cap 214 may alleviate any concerns about physical damage, or wear and tear occurring to the end portion 202 of the cowl part 106. In FIG. 2, the pivot cap 214 is shown to have a substantially non-linear shape or a substantially circular shape, which is merely an example that should not be construed as limiting the disclosure. The shape of the pivot cap 214 may be associated with a cross section of the end portion 202 of the cowl part 106.

The grommet 216 may be a ring or edge strip that may be put through a thin material hole, usually in the form of a sheet of metal, wood, honeycomb, or carbon fiber composite. By way of example, and not limitation, the grommet 216 may be made of rubber. Additionally, or alternatively, the grommet 216 may be made of plastic, or metal and are flared or collared on both sides. The grommet 216 may be disposed between the end portion 202 of the cowl part 106 and the pivot cap 214. In certain embodiments, the grommet 216 may be configured to seal the end portion 202 of the cowl part 106 with the pivot cap 214 to alleviate any concern of water intrusion into the pocket 210 and the engine compartment of the vehicle 102.

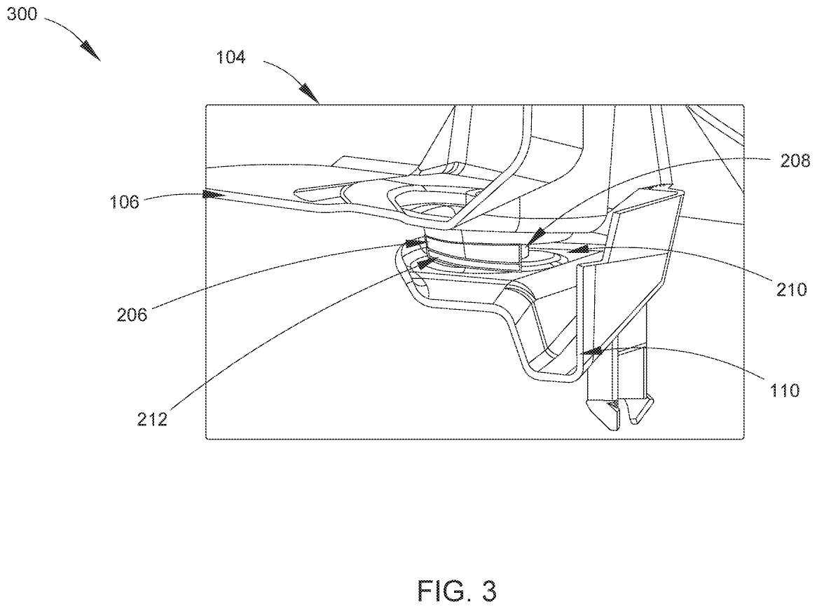

FIG. 3 is a diagram that illustrates a side cross sectional view of a cowl structure for a vehicle, in accordance with an embodiment of the disclosure. FIG. 3 is explained in conjunction with elements from FIG. 1 and FIG. 2. With reference to the FIG. 3, there is shown a diagram 300 that includes a cross sectional view of the cowl structure 104. The cowl structure 104 may include the cowl part 106 that may be configured to mount the wiper assembly 108 of the vehicle 102. The wiper assembly 108 may further include the pivot point 208 that may rotatable couple with the end portion 202 of the cowl part 106. Further, the wiper cover 110 may be disposed on the wiper assembly 108. The slider 206 may have the first end segment 206A and the second end segment 206B. The first end segment 206A may be disposed on the underside 204 of the cowl part 106. The second end segment 206B of the slider 206 may meet up with the wiper cover 110 such that the pocket 210 is formed around the pivot point 208 of the wiper assembly 108 of the vehicle 102. The pocket 210 may be a vacant space that may be formed around the pivot point 208 of the wiper assembly 108. Additionally, the pocket 210 may be a vacant space formed between the cowl part 106, the slider 206, and the wiper cover 110, as explained in detail, for example, in FIG. 1 and FIG. 2.

It should be noted that the diagram 300 of FIG. 3 is for exemplary purposes and should not be construed to limit the scope of the disclosure.

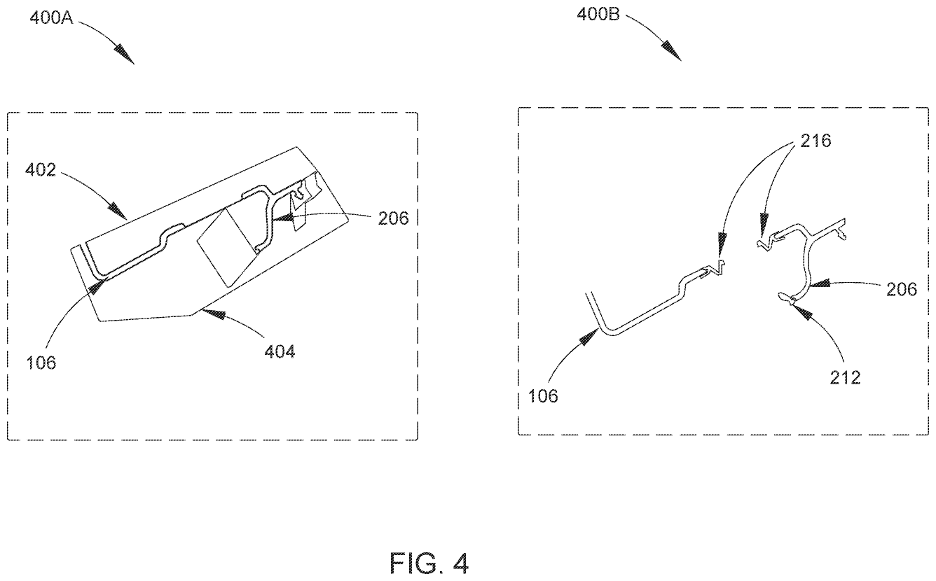

FIG. 4 is a diagram that illustrates a formation of a cowl structure for a vehicle, in accordance with an embodiment of the disclosure. FIG. 4 is explained in conjunction with elements from FIG. 1, FIG. 2, and FIG. 3. With reference to the FIG. 4, there are shown two scenario diagrams 400A and 400B that illustrate a formation of the cowl structure 104 for the vehicle 102. The cowl structure 104 may include an upper die 402 and a lower die 404.

In 400A, the upper die 402 and the lower die 404 may be specialized machine tools that may be used to cut and/or shape material into required shape or profile. For example, the upper die 402 and the lower die 404 may be used in molding. Further drawing the upper die 402 and the lower die 404 against each other may be used in the production of objects, using at least a press. The upper die 402 may be placed in contact with the cowl part 106. The lower die 404 may be placed in contact with the slider 206. In the event of formation of the slider 206 with the cowl part 106 of the vehicle 102, the upper die 402 and the lower die 404 may be pressed against each other.

In 400B, the cowl structure 104 may include the slider 206 that may be attached with the underside 204 of the cowl part 106. The gasket 212 may be disposed on the slider 206 after the upper die 402 and the lower die 404 are disengaged from each other. Further, the grommet 216 may be disposed on the end portion 202 of the cowl part 106.

It should be noted that formation of the cowl structure 104 as shown in FIG. 4 is for exemplary purposes and should not be construed to limit the scope of the disclosure.

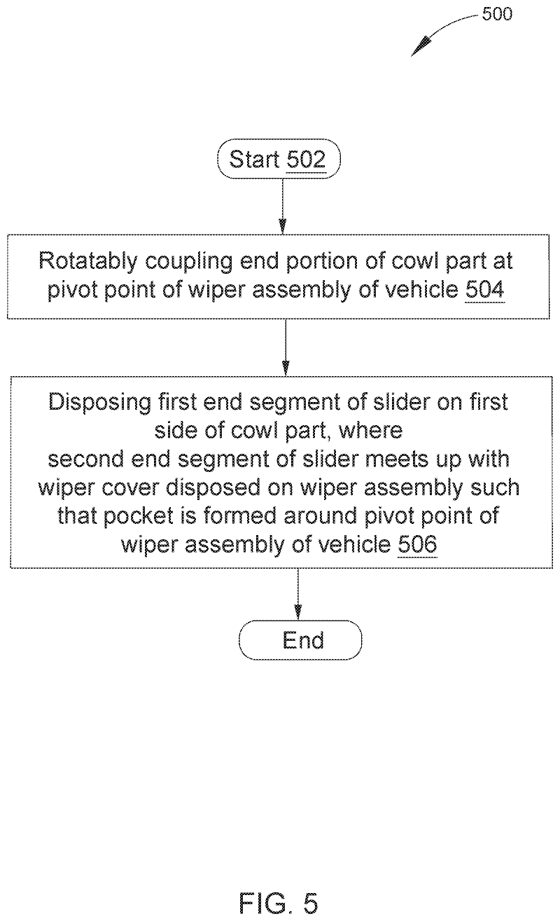

FIG. 5 is a flowchart that illustrates an exemplary method of adding a slider to a cowl part of a vehicle, in accordance with an embodiment of the disclosure. FIG. 5 is explained in conjunction with elements from FIG. 1, FIG. 2, FIG. 2, and FIG. 4. With reference to FIG. 5, there is shown a flowchart 500, which may depict a method of adding the slider 206 to the cowl part 106 of the vehicle 102. The method illustrated in the flowchart 500 may start at 502 and proceed to 504.

At 504, the end portion 202 of the cowl part 106 may be rotatably coupled at the pivot point 208 of the wiper assembly 108 of the vehicle 102. Further details regarding rotatably coupling the end portion 202 of the cowl part 106 at the pivot point 208 of the wiper assembly 108, is described in detail, for example, in FIG. 1 and FIG. 2.

At 506, the first end segment 206A of the slider 206 may be disposed on the underside 204 of the cowl part 106. Further, the second end segment 206B of the slider 206 may meet up with the wiper cover 110 that may be disposed on the wiper assembly 108 such that the pocket 210 is formed around the pivot point 208 of the wiper assembly 108 of the vehicle 102, as described in detail, for example, in FIG. 1, FIG. 2, and FIG. 3.

Although the flowchart 500 is illustrated as discrete operations, such as 502, 504, and 506, the disclosure is not so limited. Accordingly, in certain embodiments, such discrete operations may be further divided into additional operations, combined into fewer operations, or eliminated, depending on the particular implementation without detracting from the essence of the disclosed embodiments.

For the purposes of the present disclosure, expressions such as “including”, “comprising”, “incorporating”, “consisting of”, “have”, “is” used to describe and claim the present disclosure are intended to be construed in a non-exclusive manner, namely allowing for items, components or elements not explicitly described also, to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible considering the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

What is claimed is:

1. A cowl structure for a vehicle, comprising:
a cowl part having an end portion that is rotatably coupled at a pivot point of a wiper assembly of the vehicle; and
a slider having a first end segment and a second end segment,
wherein the first end segment is disposed on an underside of the cowl part, and
the second end segment meets up with a wiper cover disposed on the wiper assembly such that a pocket is formed around the pivot point of the wiper assembly of the vehicle.

2. The cowl structure according to claim 1, further comprising a gasket that is disposed between the second end segment of the slider and the wiper cover.

3. The cowl structure according to claim 2, wherein the gasket is a dual injected mechanical seal that is configured to secure the second end segment of the slider to the wiper cover.

4. The cowl structure according to claim 1, further comprising a pivot cap that is disposed between the end portion of the cowl part and the pivot point of the wiper assembly of the vehicle.

5. The cowl structure according to claim 1, further comprising a grommet that is disposed between the end portion of the cowl part and a pivot cap.

6. The cowl structure according to claim 1, wherein the cowl part may be disposed between a rear end of a front hood and a bottom portion of a front wind shield of the vehicle.

7. The cowl structure according to claim 1, wherein the underside of the cowl part is a bottom side of the cowl part.

8. The cowl structure according to claim 1, wherein the pivot point of the wiper assembly of the vehicle is located on at least a driver side portion, or a middle portion of a front wind shield of the vehicle.

9. The cowl structure according to claim 1, wherein the pocket is a vacant space formed between the cowl part, the slider, and the wiper cover.

10. The cowl structure according to claim 1, wherein the pocket seals the wiper cover around the pivot point of the wiper assembly to provide an additional structure that is configured to prevent water intrusion.

11. A vehicle body structure, comprising:
a cowl structure that includes:
a cowl part having an end portion that is rotatably coupled at a pivot point of a wiper assembly of a vehicle; and
a slider having a first end segment and a second end segment, wherein,
the first end segment is disposed on an underside of the cowl part, and
the second end segment meets up with a wiper cover disposed on the wiper assembly, such that a pocket is formed around the pivot point of the wiper assembly of the vehicle.

12. The vehicle body structure according to claim 11, further comprising a gasket that is disposed between the second end segment of the slider and the wiper cover.

13. The vehicle body structure according to claim 12, wherein the gasket is a dual injected mechanical seal that is configured to secure the second end segment of the slider to the wiper cover.

14. The vehicle body structure according to claim 11, further comprising:
a pivot cap that is disposed between the end portion of the cowl part and the pivot point of the wiper assembly of the vehicle; and
a grommet that is disposed between the end portion of the cowl part and the pivot cap.

15. The vehicle body structure according to claim 11, wherein
the pocket is a vacant space formed between the cowl part, the slider, and the wiper cover; and
the pocket seals the wiper cover around the pivot point of the wiper assembly to provide an additional structure that is configured to prevent water intrusion.

16. A method of adding a slider to a cowl part of a vehicle, the method comprising:
rotatably coupling an end portion of the cowl part at a pivot point of a wiper assembly of the vehicle; and
disposing a first end segment of the slider on an underside of the cowl part,
wherein a second end segment of the slider meets up with a wiper cover disposed on the wiper assembly such that a pocket is formed around the pivot point of the wiper assembly of the vehicle.

17. The method according to claim 16, further comprising disposing a gasket between the second end segment of the slider and the wiper cover.

18. The method according to claim 17, wherein the gasket is a dual injected mechanical seal that is configured to secure the second end segment of the slider to the wiper cover.

19. The method according to claim 16, further comprising:
disposing a pivot cap between the end portion of the cowl part and the pivot point of the wiper assembly of the vehicle; and
disposing a grommet between the end portion of the cowl part and the pivot cap.

20. The method according to claim 16, wherein
the pocket is a vacant space formed between the cowl part, the slider and the wiper cover; and
the pocket seals the wiper cover around the pivot point of the wiper assembly to provide an additional structure that is configured to prevent water intrusion.
